(19) United States
(12) Patent Application Publication
(10) Pub. No.: US 2026/0061363 A1
(43) Pub. Date: Mar. 5, 2026

(54) CONCEPT FOR INTEGRATION OF A MOBILE CARBON CAPTURE SYSTEM WITH AN INTERNAL COMBUSTION ENGINE

(71) Applicant: SAUDI ARABIAN OIL COMPANY, Dhahran (SA)

(72) Inventors: Alexander Voice, Detroit, MI (US); Andrew Baur, Whitmore Lake, MI (US); David Cleary, West Bloomfield, MI (US); Esam Hamad, Brighton, MI (US); Kaustav Bhadra, Ann Arbor, MI (US); Chanel Sitto, West Bloomfield, MI (US)

(73) Assignee: ARAMCO SERVICES COMPANY, Houston, TX (US)

(21) Appl. No.: 18/820,929

(22) Filed: Aug. 30, 2024

(51) Int. Cl. B01D 53/14; B01D 53/34; B01D 53/62

(52) U.S. Cl. CPC B01D 53/1475; B01D 53/1425; B01D 53/343; B01D 53/62; B01D 2257/504; B01D 2258/01

(57) ABSTRACT

A method to reduce carbon dioxide emissions from an engine including combusting fuel in the engine to yield exhaust gas, feeding a coolant to the engine head at a first temperature, and recovering an engine coolant at a second temperature. The method further includes flowing a first portion of the engine head coolant through a restricting valve to increase a temperature of the first portion of the engine head coolant to a third temperature, feeding the first portion of the engine head coolant from the restricting valve to the engine block, and recovering an engine block coolant at a fourth temperature. A second portion of the engine head coolant is recirculated back to the engine head. A system including an engine head, an engine block, a restricting valve in a first flow line, and a second flow line exiting the engine head to recirculate coolant back towards the engine head.

### BACKGROUND

Current research on internal combustion engines is often focused around improving efficiency and reducing carbon dioxide emissions concurrently. Data indicates that maintaining low coolant temperatures reduces the chances of knock in gasoline spark ignited engines and reduces NOx emissions in diesel engines. Research shows that maintaining low temperatures of coolant in the engine head specifically has a more significant impact on knock mitigation than the temperature of the coolant in the engine block.

Research indicates that maintaining high engine coolant temperatures reduces unburnt hydrocarbon and particulate matter emissions due to subsequent oxidation of fuel molecules that may impinge the walls during injection and get stuck in the crevices above the piston ring in gasoline engines. In diesel engines, carbon monoxide and soot emissions are minimized at high engine coolant temperatures. In addition to improving the efficiency of the internal combustion engine, carbon dioxide emissions can be further reduced using carbon capture technologies in a mobile configuration.

Accordingly, there exists a need for a technology that may leverage the benefits of both low temperature coolant in the engine head and high temperature coolant in the engine block for internal combustion engines while simultaneously capturing the emissions that are released, thus resulting in high efficiency, lesser emissions, and a lower likelihood of knock.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method to reduce carbon dioxide emissions from an engine including combusting a fuel in the engine to yield an exhaust gas. In this method, the engine includes at least an engine head and an engine block. The coolant is fed to the engine head at a first temperature and an engine head coolant is recovered at a second temperature. A first portion of the engine head coolant flows through a restricting valve to increase a temperature of the first portion of the engine head coolant to a third temperature. The first portion of the engine head coolant is fed from the restricting valve to the engine block, recovering an engine block coolant at a fourth temperature. A second portion of the engine head coolant is recirculated back to the engine head.

Embodiments disclosed herein relate to a system for capturing carbon dioxide emissions from an engine that includes an engine head and an engine block. A restricting valve is situated in a first flow line exiting the engine head and increases the temperature of a first portion of an engine head coolant flowing between the engine head and the engine block. A second flow line exits the engine head and is configured to recirculate a second portion of the engine head coolant back toward the engine head.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIG. 1 is a detailed overall process flow diagram in accordance with one or more embodiments.

FIG. 2 is a process flow diagram of an engine coolant loop in accordance with one or more embodiments.

FIG. 3 is a process flow diagram of an absorber and regeneration column with heat exchangers in series in accordance with one or more embodiments.

FIG. 4 is a process flow diagram of an absorber and regeneration column with heat exchangers in parallel in accordance with one or more embodiments.

FIG. 5 is a process flow diagram of an absorber and regeneration column with heat exchangers in separate solvent loops in accordance with one or more embodiments.

FIG. 6A is a graph of brake thermal efficiency (%) of a gasoline internal combustion engine in accordance with one or more embodiments.

FIG. 6B is a graph of brake thermal efficiency (%) of a gasoline internal combustion engine in accordance with one or more embodiments.

FIG. 7A is a graph of unburnt hydrocarbon emissions (ppm) of a gasoline internal combustion engine in accordance with one or more embodiments.

FIG. 7B is a graph of unburnt hydrocarbon emissions (ppm) of a gasoline internal combustion engine in accordance with one or more embodiments.

FIG. 8A is a graph of filter smoke number for a diesel internal combustion engine in accordance with one or more embodiments.

FIG. 8B is a graph of filter smoke number for a diesel internal combustion engine in accordance with one or more embodiments.

FIG. 9A is a graph of frictional mean effective pressure (bar) of a diesel internal combustion engine in accordance with one or more embodiments.

FIG. 9B is a graph of frictional mean effective pressure (bar) of a diesel internal combustion engine in accordance with one or more embodiments.

FIG. 10A is a graph of brake thermal efficiency (%) for a diesel internal combustion engine in accordance with one or more embodiments.

FIG. 10B is a graph of brake thermal efficiency (%) for a diesel internal combustion engine in accordance with one or more embodiments.

FIG. 11A is a graph of carbon monoxide emissions (ppm) for a diesel internal combustion engine in accordance with one or more embodiments.

FIG. 11B is a graph of carbon monoxide emissions (ppm) for a diesel internal combustion engine in accordance with one or more embodiments.

FIG. 12A is a graph of NOx emissions (ppm) for a diesel internal combustion engine in accordance with one or more embodiments.

FIG. 12B is a graph of NOx emissions (ppm) for a diesel internal combustion engine in accordance with one or more embodiments.

FIG. 13A is a graph of heat rejected (kW) to coolant from a gasoline internal combustion engine in accordance with one or more embodiments.

FIG. 13B is a graph of heat rejected (kW) to coolant from a gasoline internal combustion engine in accordance with one or more embodiments.

FIG. 14A is a graph of heat rejected (kW) to coolant for a diesel internal combustion engine in accordance with one or more embodiments.

FIG. 14B is a graph of heat rejected (kW) to coolant for a diesel internal combustion engine in accordance with one or more embodiments.

FIG. 15A is a bar graph of fuel energy (%) lost to the coolant and the exhaust against engine load from a gasoline internal combustion engine in accordance with one or more embodiments.

FIG. 15B shows available heat (kW) used in a mobile carbon capture system against engine load from a gasoline internal combustion engine in accordance with one or more embodiments.

FIG. 16A is a bar graph of fuel energy (%) lost to the coolant and the exhaust against engine load from a diesel internal combustion engine in accordance with one or more embodiments.

FIG. 16B shows available heat (kW) used in a mobile carbon capture system against engine load from a diesel internal combustion engine in accordance with one or more embodiments.

### DETAILED DESCRIPTION

In one aspect, embodiments disclosed herein relate to a method for capturing carbon dioxide emissions from an internal combustion engine. Embodiments disclosed herein relate to a method for flowing engine coolant into the engine head at a set temperature, splitting the engine coolant exiting the engine head to direct a portion of the engine coolant to the engine block at a higher temperature, and recycling the other portion of the engine coolant. Embodiments disclosed herein relate to a method for using heat exchangers, an absorber, and a regeneration column with the engine coolant and exhaust gas from the internal combustion engine to capture carbon dioxide from the exhaust gas for storage. Embodiments disclosed herein relate to a method wherein an engine, absorber, regeneration column, crossflow heat exchanger, and rich solvent heater are disposed in an automobile.

In one aspect, embodiments disclosed herein relate to a system for capturing carbon dioxide emissions from an internal combustion engine. Embodiments disclosed herein relate to a system including an internal combustion engine with an engine head, where the engine head contains cylinder heads, and where fuel and air may be injected into the cylinders situated in the engine block. Embodiments disclosed herein relate to a system where the coolant is fed at different temperatures to the engine head and the engine block to optimize performance, efficiency, and reduce knock. The coolant circulating contains ethylene glycol at a temperature between 100 to 135° C. In one or more embodiments, at least 50% ethylene glycol is used to avoid high pressure in the coolant circuit. In one or more embodiments, 60-90% ethylene glycol is the optimal range to reduce the coolant pressure.

In some embodiments, the system may include two coolant recirculation loops. In these configurations, an engine coolant loop provides coolant to an engine head and an engine block at specified temperatures. The coolant is heated by the engine head and engine block. A first portion of the coolant may flow from the engine head to the engine block through a restricting valve, upstream of the engine block. A second portion of the coolant may recycle back to the engine head inlet after passing through the engine head. The heat from the coolant exiting the engine block is transferred to the carbon capture system, specifically via a rich solvent heater. This coolant is recycled to be pumped back into the engine head at a specified temperature. The coolant may be at a first temperature between 60 and 90° C. as it flows into the engine head. The engine head coolant may be at a second temperature, greater than the first temperature, between 90 and 110° C. as it flows out of the engine head.

The difference between the first temperature and the second temperature may be monitored and/or controlled to optimize the engine design and calibration for improved performance and emissions. For example, improved knock tolerance in gasoline spark ignition engines and reduced NOx emissions in diesel engines allowing greater flexibility in the air to fuel ratio. The engine head coolant flowing out of the engine head to the engine block will flow through a restricting valve, raising the temperature to a third temperature between 110 and 125° C. The engine block coolant flowing out of the engine block may be at a fourth temperature between 125 and 150° C. The second coolant recirculation loop includes a first heat exchanger that may cool a second coolant to a temperature below 40° C. The second coolant is pumped in a cold coolant pump to several coolers.

In one or more embodiments, the coolers include an exhaust trim cooler, a lean solvent trim cooler, a carbon dioxide heat exchanger (e.g., a condenser), and a compressor. In each, the second coolant recovers heat and circulates back to the first heat exchanger to be cooled and reused in the second coolant recirculation loop. Using the second coolant, the exhaust trim cooler may cool the cooled exhaust to a temperature between 20 and 80° C. Using the second coolant, the lean solvent trim cooler may cool the first cooled carbon dioxide lean solvent to a temperature between 20 and 80° C. Using the second coolant, the carbon dioxide heat exchanger may cool the carbon dioxide stream to a temperature between 20 and 80° C. The compressor may use the second coolant for cooling purposes to prevent overheating. In other embodiments, the temperature ranges of the cooled exhaust, the carbon dioxide lean solvent, the carbon dioxide stream, and/or the second carbon dioxide stream may be different depending upon the particular application. Based upon the disclosure provided herein, one of ordinary skill in the art will recognize a variety of temperature ranges that may be used in relation to different embodiments.

In some embodiments, the system may include one coolant recirculation loop. Similar to the two coolant recirculation loop configuration, the coolant is heated by the engine head and engine block. The coolant may be at a first temperature between 60 and 90° C. as it flows into the engine head. The engine head coolant may be at a second temperature between 70 and 100° C. as it flows out of the engine head. The first portion of the engine head coolant flowing to the engine block will flow through a restricting valve, raising the temperature to a third temperature between 90 and 100° C. The engine block coolant flowing out of the engine block may be at a fourth temperature between 100 and 120° C. The engine block coolant flows to a coolant-exhaust heat exchanger that may heat the engine block coolant using exhaust gas to a temperature between 120 and 150° C., producing a heated engine block coolant. The heated engine block coolant may be used to provide heat to carbon capture heaters, including a lean solvent heater, producing a cooled engine block coolant.

A second portion of the coolant exiting the engine head may recycle back to the engine head inlet, combining with the cooled engine block coolant at a three-way valve. The combined stream may flow through a second heat exchanger, cooling the combined coolant stream to a temperature below 40° C. to allow it to be used for cooling carbon capture coolers. This combined coolant stream may be pumped to the carbon capture coolers including an exhaust trim cooler, a lean solvent trim cooler, a carbon dioxide heat exchanger, and a compressor, producing the coolant that is fed to the engine head in this one coolant recirculation loop.

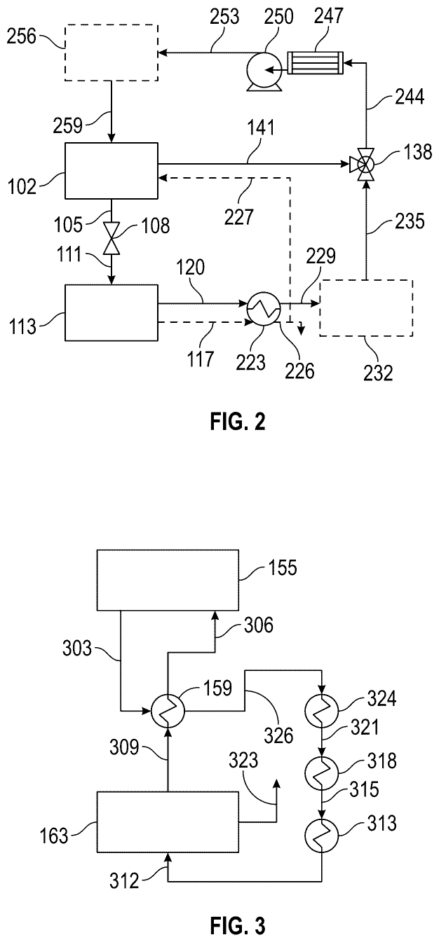

The carbon capture portion of the system includes the absorber, regeneration column, carbon storage, and the heat exchangers supporting this process. In one or more embodiments, the regeneration column is a stripper. In one or more embodiments, a flash tank may be used in place of a regeneration column to generate the solvent. When referring to carbon capture heaters, this includes at least the lean solvent heater. When referring to carbon capture coolers, this includes at least the exhaust trim cooler, the lean solvent trim cooler, the carbon dioxide heat exchanger, and the compressor (See FIG. 2, 256). The exhaust gas exiting the internal combustion engine may be at a temperature between 100 and 1000° C., and may contain between 7 to 12% carbon dioxide.

In one or more embodiments, the carbon capture heaters (See FIG. 2, reference 232) may be heated using hot exhaust, hot coolant, hot lubricant, and exhaust gas recirculation (EGR). In one or more embodiments, the carbon capture coolers may be cooled using direct air cooling, direct cooling with process cooling water if available, or indirect cooling using a coolant loop which rejects heat to the ambient environment. Other configurations of heat exchangers may be utilized to support the absorber and regeneration column, as are described below in FIGS. 2-5.

The absorber is used to remove carbon dioxide from the exhaust gas of the internal combustion engine. The absorber is maintained at a temperature below 50° C. to improve the driving force for mass transfer. The regeneration column is used to regenerate the solvent used in the absorber to remove absorb the carbon dioxide when removing it from the exhaust gas. As a result of the regeneration process, carbon dioxide is separated and stored. Solvent regeneration occurs at temperatures above 100° C., preferably near 120° C., and pressures above 1 atm to reduce the amount of water that is vaporized while carbon dioxide is recovered. The solvent regeneration temperature should be below the thermal degradation temperature of the solvent used. Suitable solvents will selectively absorb carbon dioxide from the exhaust gas, such as monoethanolamine.

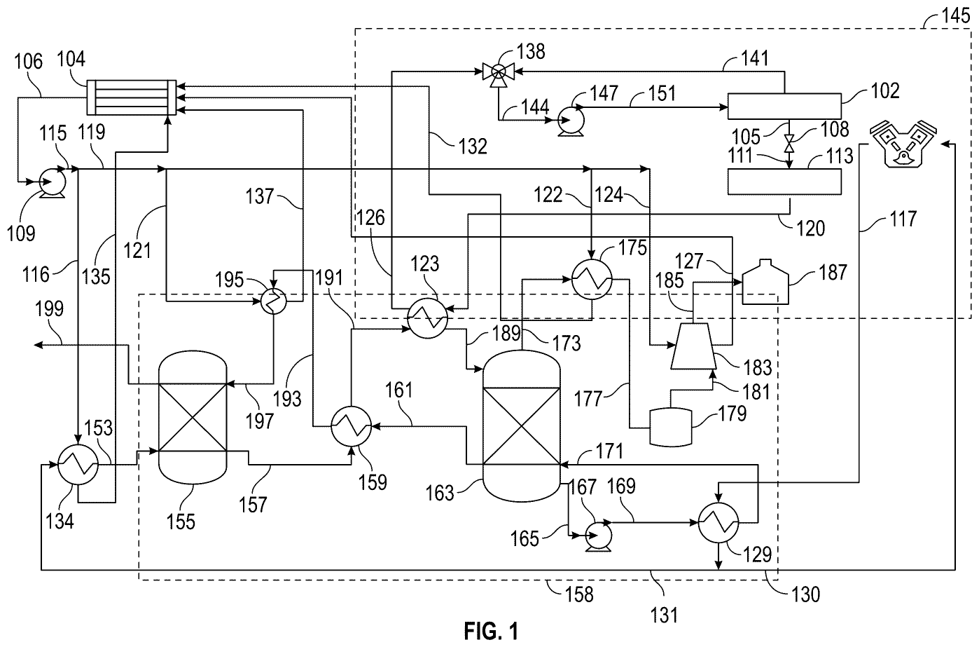

FIG. 1 illustrates a detailed overall process flow diagram in accordance with one or more embodiments. FIG. 1 includes an absorber-regeneration column section 158 and an engine section 145. FIG. 1 shows one embodiment of an engine section, but other engine sections may be used in place of engine section 145 in accordance with different embodiments. For example, FIG. 2 shows an alternative engine section that may be used in place of or in addition to engine section 145 in accordance with different embodiments. Further, FIG. 1 shows one embodiment of absorber-regeneration column section 158, but other absorber-regeneration column sections may be used in place of or in addition to absorber-regeneration column section 158 in accordance with different embodiments. For example, FIGS. 3-5 show alternative absorber-regeneration column sections that may be used in place of absorber-regeneration column section 158 in accordance with different embodiments.

Turning to FIG. 1, an internal combustion engine combusts a fuel to produce an exhaust gas. A coolant 151 is fed to an engine head 102 at a first temperature. A first portion of the engine head coolant 105 and a second portion of the engine head coolant 141 are recovered at a second temperature. The first portion of the engine head coolant 105 flows towards an engine block 113 in a first flow line containing a restricting valve 108. Restricting valve 108 may be any passage that is capable of increasing the temperature of coolant passing therethrough. Based upon the disclosure provided herein, one of ordinary skill in the art will recognize a variety of restricting valves that may be used in relation to different embodiments. Flowing through the restricting valve 108 increases the temperature of the first portion of the engine head coolant 105 to yield an engine head coolant 111 at a third temperature. The second portion of the engine head coolant 141 is recycled in a second flow line to eventually flow to back to the engine head 102. The second flow line is upstream of the engine head 102. The engine head coolant 111 at the third temperature is fed to the engine block 113, and is recovered as an engine block coolant 120 at a fourth temperature. In one or more embodiments, the engine block coolant 120 at a fourth temperature may be at a temperature between 125 and 135° C. The engine block coolant 120 at the fourth temperature indirectly contacts a first heated carbon dioxide rich solvent 191 in a rich solvent heater 123 to recover heat from the engine block coolant 120 at the fourth temperature, and produce a first cooled engine block coolant 126 and a second heated carbon dioxide rich solvent stream 189.

The rich solvent heater 123 is downstream of the engine block 113. The first cooled engine block coolant 126 is recycled to a three-way valve 138 where it combines with the second portion of the engine head coolant 141 at the second temperature, producing a combined stream 144. The combined stream 144 is pumped through a first pump 147, producing the coolant 151 that, as previously described, is fed to the engine head 102.

The engine block 113 releases exhaust gas 117. Heat from the exhaust gas 117 is recovered using a carbon dioxide lean solvent 169 in a lean solvent heater 129, downstream of the internal combustion engine, outputting a cooled exhaust 131. An exhaust gas recirculation flow line 130 branches off of the cooled exhaust 131 at the exit of the lean solvent heater 129 to recirculate a portion of the cooled exhaust back to the internal combustion engine.

A carbon dioxide lean solvent may be any solvent capable of accepting CO₂ and heat. Based upon the disclosure provided herein, one of ordinary skill in the art will recognize a variety of carbon dioxide lean solvents that may be used in relation to different embodiments. Lean solvent heater 129 may be any device capable of transferring heat from exhaust to a solvent. Based upon the disclosure provided herein, one of ordinary skill in the art will recognize a variety of lean solvent heaters that may be used in relation to different embodiments. The exhaust gas recirculation flow line 130 may subsequently exchange heat with the engine block coolant from the exhaust gas after the engine block coolant is heated using the exhaust gas in the coolant-exhaust heat exchanger (FIG. 2, reference 223).

Returning to FIG. 1, the cooled exhaust 131 flows to an exhaust trim cooler 134, which is downstream of the lean solvent heater and upstream of the absorber 155. The exhaust trim cooler 134 may be any device capable of transferring heat by contacting a second coolant 115 in a second coolant flow line 116 and outputting a second cooled exhaust 153. Based upon the disclosure provided herein, one of ordinary skill in the art will recognize a variety of exhaust trim coolers that may be used in relation to different embodiments.

The second cooled exhaust 153 is fed to an absorber 155, which is downstream of the exhaust trim cooler 134 and upstream of a regeneration column 163. Absorber 155 may be any device capable of absorbing CO₂ from exhaust. Based upon the disclosure provided herein, one of ordinary skill in the art will recognize a variety of absorbers that may be used in relation to different embodiments. The absorber 155 also receives a second cooled carbon dioxide lean solvent 197 to absorb carbon dioxide from the second cooled exhaust 153, producing a carbon dioxide rich solvent 157 and a carbon dioxide reduced exhaust stream 199. The carbon dioxide rich solvent 157 is used to heat the carbon dioxide lean solvent 161 exiting the stripper 163, and is further heated using engine coolant 120 in the rich solvent heater 123 to approximately 100° C. prior to being fed as the second heated carbon dioxide rich solvent stream 189 to the stripper 163.

The second cooled carbon dioxide lean solvent 197 was produced from a first cooled carbon dioxide lean solvent 193 entering a lean solvent trim cooler 195. Heat is transferred from a carbon dioxide lean solvent 161 to the carbon dioxide rich solvent 157 in a crossflow heat exchanger 159, producing the first cooled carbon dioxide lean solvent 193 and the first heated carbon dioxide rich solvent 191. A carbon dioxide rich solvent may be any solvent that contains CO₂ that can be released through one or more processes. Based upon the disclosure provided herein, one of ordinary skill in the art will recognize a variety of carbon dioxide rich solvents that may be used in relation to different embodiments.

The crossflow heat exchanger 159 is downstream of the absorber 155 and upstream of a carbon dioxide heat exchanger 175. The first heated carbon dioxide rich solvent 191, as discussed above, indirectly contacts the engine block coolant 120 at the fourth temperature in the rich solvent heater 123, producing the first cooled engine block coolant 126 and the second heated carbon dioxide rich solvent stream 189. The second heated carbon dioxide rich solvent stream 189 and a heated regeneration column bottom lean solvent 171 is fed to the regeneration column 163 to desorb carbon dioxide from the second heated carbon dioxide rich solvent stream 189, producing a carbon dioxide stream 173 and a carbon dioxide lean solvent 161.

The regeneration column 163 is downstream of the absorber 155 and upstream of a carbon dioxide heat exchanger 175. A regeneration column bottom lean solvent 165 is pumped from the bottom of the regeneration column 163 to a lean solvent heater 129 using a second pump 167, producing a heated regeneration column bottom lean solvent 171 that enters back into the regeneration column 163. The carbon dioxide stream 173 is condensed in the carbon dioxide heat exchanger 175, which is downstream of the regeneration column 163, through indirect contact with the second coolant 115 in a seventh coolant flow line 122. The condensed carbon dioxide stream 177 is fed to a liquid separator 179, which is downstream of the carbon dioxide heat exchanger 175.

The liquid separator 179 removes liquid from the condensed carbon dioxide stream 177, producing a second carbon dioxide stream 181. The second carbon dioxide stream 181 is compressed in a compressor 183, producing a compressed carbon dioxide stream 185. The compressor 183 is downstream of the liquid separator 179. The compressed carbon dioxide stream 185 is stored in a carbon dioxide storage unit 187. The carbon dioxide storage unit may include mobile storage tanks that may be fitted onto the vehicle. Based upon the disclosure provided herein, one of ordinary skill in the art will recognize a variety of carbon dioxide storage units that may be used in relation to different embodiments.

The second coolant 115 circulates through a first heat exchanger 104 in a second coolant recirculation loop configured to provide cold coolant to heat exchangers. In some embodiments, first heat exchanger 104 may be a radiator. Based upon the disclosure provided herein, one of ordinary skill in the art will recognize a variety of heat exchangers that may be used in relation to different embodiments. The second coolant 115 exits the first heat exchanger 104 in a first coolant flow line. The first coolant 106 is pumped through a cold coolant pump 109.

A first portion of the second coolant 115 flows through the second coolant flow line 116 to the exhaust trim cooler 134 to remove heat from the cooled exhaust 131. The first portion of the second coolant 115 exits the exhaust trim cooler at a higher temperature and flows through a third coolant flow line 135 back to the first heat exchanger 104 for cooling. A second portion of the second coolant flows through a fourth coolant flow line 119 that branches off to the lean solvent trim cooler 195, the carbon dioxide heat exchanger 175, and the compressor 183.

A third portion of the second coolant 115 flows through a fifth coolant flow line 121 to the lean solvent trim cooler 195 before recycling back to the first heat exchanger 104 in a sixth coolant flow line 137. A fourth portion of the second coolant 115 flows through the seventh coolant flow line 122 to the carbon dioxide heat exchanger 175 before recycling back to the first heat exchanger 104 in the eighth coolant flow line 132. A fifth portion of the second coolant 115 flows through a ninth coolant flow line 124 to the compressor 183 before recycling back to the first heat exchanger 104 in the tenth coolant flow line 127.

FIG. 2 illustrates a process flow diagram of an engine coolant loop for the engine section of FIG. 1. An internal combustion engine combusts a fuel to produce an exhaust gas. The coolant 259 is fed to the engine head 102 at a first temperature, recovering an engine head coolant at a second temperature. A first portion of the engine head coolant 105 at the second temperature flows towards the engine block 113, in a first flow line containing a restricting valve 108, increasing the temperature of the engine head coolant 111 to a third temperature. The second portion of the engine head coolant 141 at the second temperature is recycled in a second flow line to eventually flow to the engine head 102. The engine head coolant 111 at the third temperature is fed to the engine block 113, recovering an engine block coolant 120 at a fourth temperature. The engine block coolant 120 at the fourth temperature indirectly contacts exhaust gas 117 in a coolant-exhaust heat exchanger 223 to recover heat from the exhaust gas 117, producing a heated engine block coolant 229 and a cooled exhaust gas 226. In one or more embodiments, a second portion of the cooled exhaust gas 227 splits off from the cooled exhaust gas 226 to recycle to the engine head 102 to be used as exhaust gas recirculation (EGR). Using EGR may lower the oxygen concentration and flame temperature in the combustion chamber of the engine, reducing NOₓ emissions.

The heated engine block coolant 229 exiting the second heat exchanger 247 may feed heaters in the carbon capture portion of the system, including the lean solvent heater (FIGS. 1, 129), producing a cooled engine block coolant 235. The second heat exchanger 247 is situated downstream of the rich solvent heater 123 and upstream of the engine head 102. The cooled engine block coolant intersects with a three-way valve 138 where it combines with the second portion of the engine head coolant 141 at the second temperature, producing a combined coolant stream 244. The combined coolant stream 244 is pumped through a third pump 250, producing the pumped combined coolant 253. The pumped combined coolant 253 exiting the second heat exchanger 247 may feed coolers in the carbon capture portion of the system, including the exhaust trim cooler (FIGS. 1, 134), the lean solvent trim cooler (FIGS. 1, 195), the carbon dioxide heat exchanger (FIGS. 1, 122), and the compressor (FIGS. 1, 183), producing the coolant 259 that is fed to the engine head 102.

FIG. 3 illustrates a process flow diagram of an absorber and regeneration column with heat exchangers arranged in series in place of the absorber-regeneration column section of FIG. 1. The absorber 155 produces a carbon dioxide rich solvent 303 and receives a cooled carbon dioxide lean solvent 306. The crossflow heat exchanger 159 heats the carbon dioxide rich solvent 303, producing a first heated carbon dioxide rich solvent stream 326. The first heated carbon dioxide rich solvent stream 326 is heated in a rich solvent heater 324, producing a second heated carbon dioxide rich solvent stream 321.

A second rich solvent heater 318 is in series with the rich solvent heater 324. The second heated carbon dioxide rich solvent stream 321 is heated in the second rich solvent heater 318, producing a third heated carbon dioxide rich solvent stream 315. A third rich solvent heater 313 is in series with the second rich solvent heater 318. The third heated carbon dioxide rich solvent stream 315 is heated in the third rich solvent heater 313, producing a fourth heated carbon dioxide rich solvent stream 312, which flows to the regeneration column 163.

The regeneration column 163 produces a carbon dioxide lean solvent 309 and a carbon dioxide stream 323. The carbon dioxide lean solvent 309 provides heat to the carbon dioxide rich solvent 303 in the crossflow heat exchanger 159. In one or more embodiments, the second rich solvent heater 318 and third rich solvent heater 313 may use heat from the exhaust gas. By heating the carbon dioxide rich solvent stream in series, the resulting fourth heated carbon dioxide rich solvent stream may be heated to a temperature between 100 and 150° C., ensuring effective stripping. During operation, a pressure in each effluent line, including the second heated carbon dioxide rich solvent stream 321, the third heated carbon dioxide rich solvent stream 315, and the fourth heated carbon dioxide rich solvent stream 312, exiting each of the rich solvent heaters is regulated to ensure that the temperature does not exceed 125° C., or the thermal degradation temperature of the solvent used, as discussed previously.

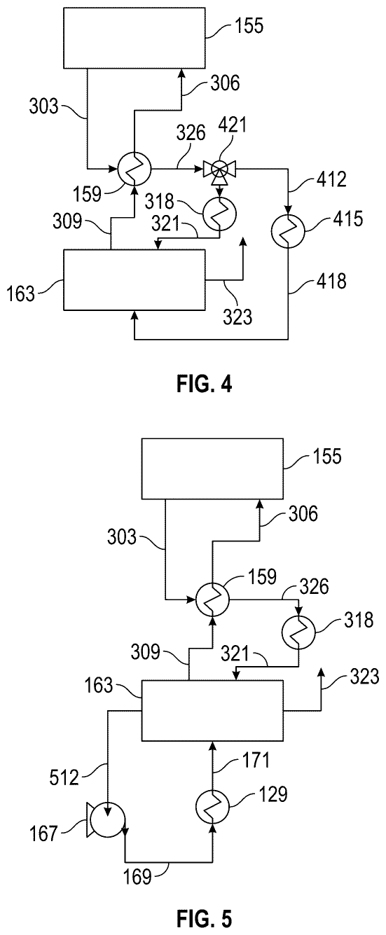

FIG. 4 illustrates a process flow diagram of an absorber and regeneration column with heat exchangers arranged in parallel in place of the absorber-regeneration column section of FIG. 1. The absorber 155 produces a carbon dioxide rich solvent 303 and receives a cooled carbon dioxide lean solvent 306. The crossflow heat exchanger 159 heats the carbon dioxide rich solvent 303, producing a first heated carbon dioxide rich solvent stream 326. The first heated carbon dioxide rich solvent stream 326 splits into two pathways using a second three-way valve 421.

In one pathway, the first heated carbon dioxide rich solvent 326 is heated in a rich solvent heater 318, producing a second heated carbon dioxide rich solvent stream 321 flowing into the regeneration column 163. The second pathway flows a second portion of the first heated carbon dioxide rich solvent stream 412 to a fourth rich solvent heater 415, producing a fifth heated carbon dioxide rich solvent stream 418 flowing into the regeneration column 163. In one or more embodiments, the second heated carbon dioxide rich solvent stream 321 and the fifth heated carbon dioxide rich solvent stream 418 enter into the regeneration column 163 through different inlet locations on the regeneration column 163.

The regeneration column 163 produces a carbon dioxide lean solvent 309 and a carbon dioxide stream 323. The carbon dioxide lean solvent 309 provides heat to the carbon dioxide rich solvent 303 in the crossflow heat exchanger 159. In one or more embodiments, the fourth rich solvent heater may use heat from the exhaust gas. By using two rich solvent heaters in parallel, the heated carbon dioxide rich solvent streams may be added to the regeneration column at different locations in the column and at specified temperatures.

FIG. 5 illustrates process flow diagram of an absorber and regeneration column with heat exchangers. FIG. 5 is similar to the embodiment illustrated within FIG. 1, without the lean solvent trim cooler (FIGS. 1, 195). The absorber 155 produces a carbon dioxide rich solvent 303 and receives a cooled carbon dioxide lean solvent 306. The crossflow heat exchanger 159 heats the carbon dioxide rich solvent 303, producing a first heated carbon dioxide rich solvent stream 326. The first heated carbon dioxide rich solvent stream 326 is heated in a rich solvent heater 318, producing a second heated carbon dioxide rich solvent stream 321 flowing into the regeneration column 163. The regeneration column 163 produces a carbon dioxide lean solvent 309, a carbon dioxide stream 323 that enters a condenser downstream, and a regeneration column bottom lean solvent 512.

The second regeneration column bottom lean solvent 512 is pumped from the bottom of the regeneration column 163 to a lean solvent heater 129 using a second pump 167, producing a heated regeneration column bottom lean solvent 171 that enters back into the regeneration column 163. The carbon dioxide lean solvent 309 provides heat to the carbon dioxide rich solvent 303 in the crossflow heat exchanger 159. In one or more embodiments, the rich solvent heater 318 may use heat from the exhaust gas.

### EXAMPLE

Experimentation was conducted to prove the benefits of low coolant temperature, high coolant temperature, and system efficiency in both gasoline and diesel internal combustion engines. Experimentation was conducted across a range of different coolant temperatures and multiple speed-load combinations.

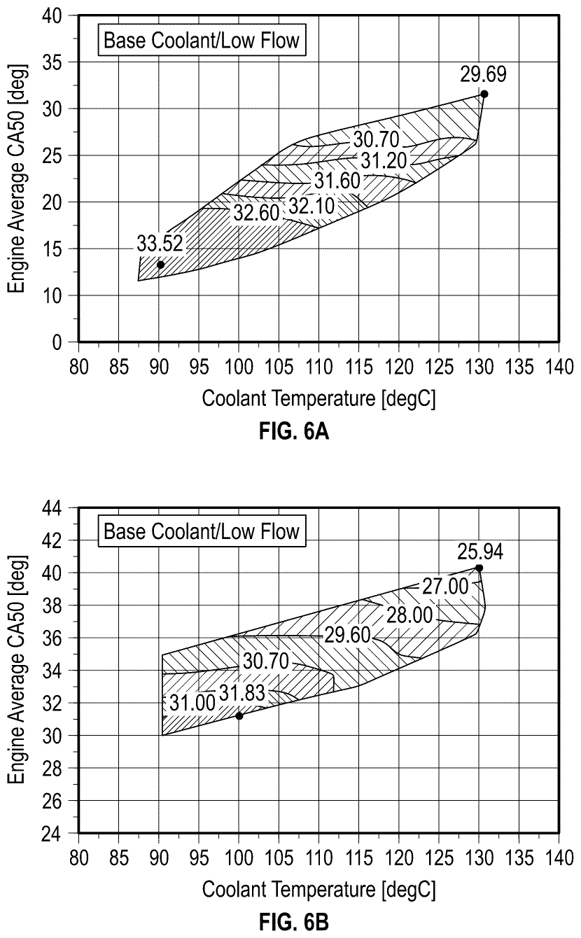

FIGS. 6A and 6B show contour plots of brake thermal efficiency (%) against engine average crank angle 50 (CA50) and coolant temperature. FIG. 6A is at engine conditions of 1500 rpm and 10 bar brake mean effective pressure (BMEP), while FIG. 6B is at 2000 rpm and 15 bar BMEP. CA50 indicates the angle in which 50% of the total fuel has been burned. As shown in FIGS. 6A and 6B, lower coolant temperatures reduce the propensity of knock in gasoline engines, which allows for advanced combustion phasing. Advancing the CA50 at knock limited conditions increases the thermal efficiency of the engine.

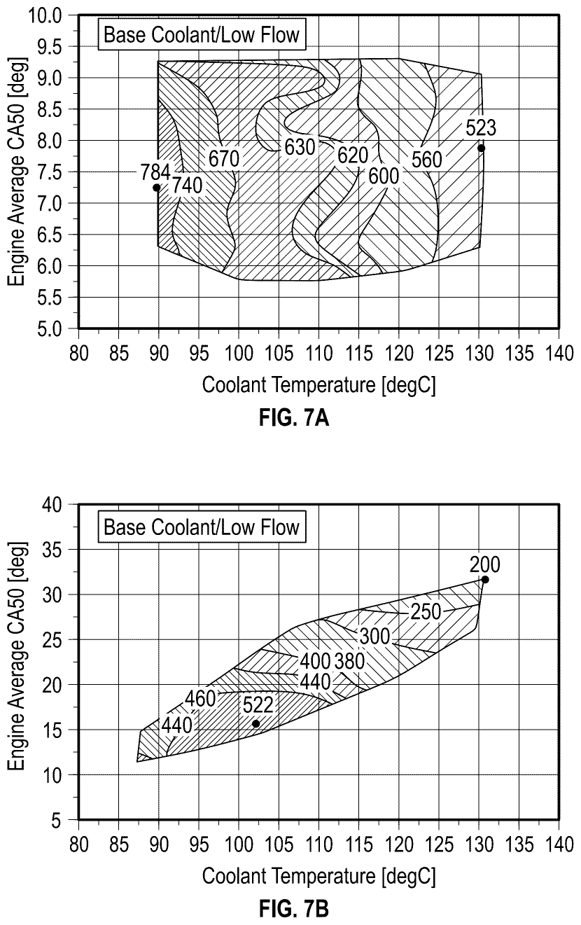

FIGS. 7A and 7B show contour plots of unburnt hydrocarbon emissions (ppm) against engine average crank angle 50 (CA50) and coolant temperature. FIG. 7A is at engine conditions of 1500 rpm and 5 bar BMEP, while FIG. 7B is at 1500 rpm and 10 bar BMEP. Both FIGS. 7A and 7B show engine average CA50 against coolant temperature with unburnt hydrocarbon emissions indicated on the graph itself numerically. Both FIGS. 7A and 7B show that levels of unburnt hydrocarbon emissions are higher at lower coolant temperatures, indicating that high coolant temperatures result in less unburnt hydrocarbon emissions.

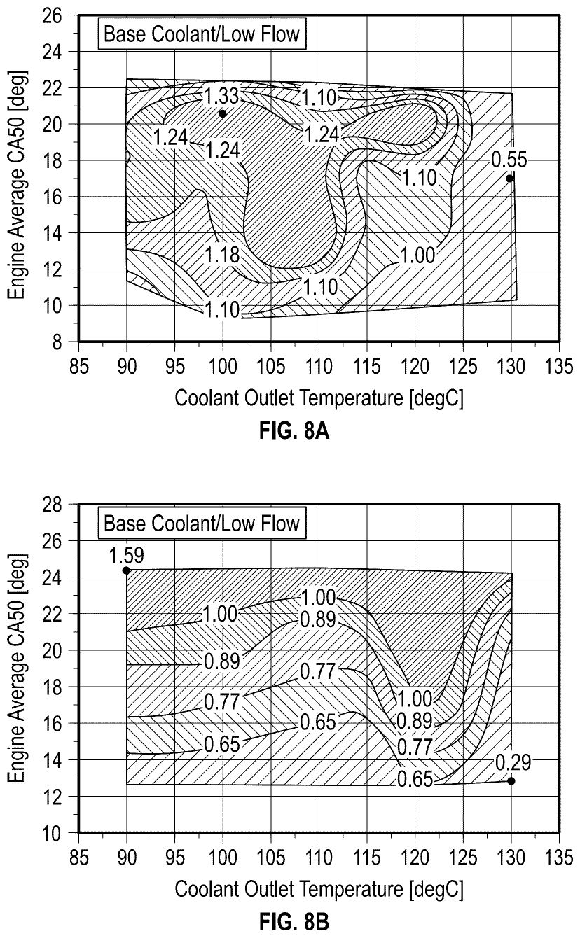

FIGS. 8A and 8B show contour plots of filter smoke number for diesel engines against engine average CA50 and coolant temperatures. Filter smoke number is a unitless number which is an indication of the opacity of the engine exhaust. It is proportional to the particulate mass in the engine exhaust. FIG. 8A is at engine conditions of 1500 rpm and 5bar BMEP, while FIG. 8B is at 1500 rpm and 10 bar BMEP. Both FIGS. 8A and 8B show that at higher coolant temperatures, there is a reduction in particulate matter emissions due to high in-cylinder temperatures.

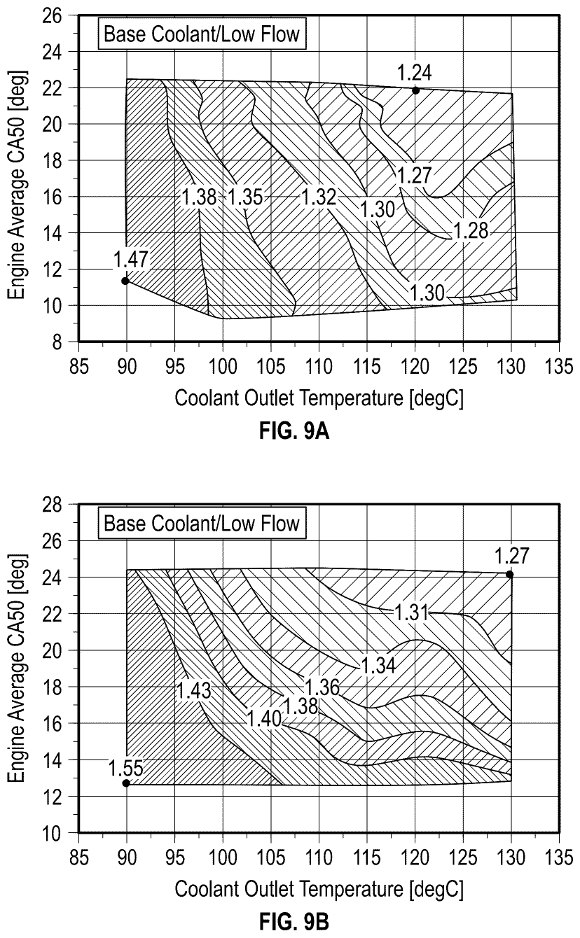

FIGS. 9A and 9B show contour plots of frictional mean effective pressure (bar) for diesel engines graphs against engine average CA50 and coolant temperatures. FIG. 9A is at engine conditions of 1500 rpm and 5 bar BMEP, while FIG. 9B is at 1500 rpm and 10 bar BMEP. As shown in FIGS. 9A and 9B, high coolant temperatures lead to high oil temperatures which results in low frictional losses, contributing to increased thermal efficiency.

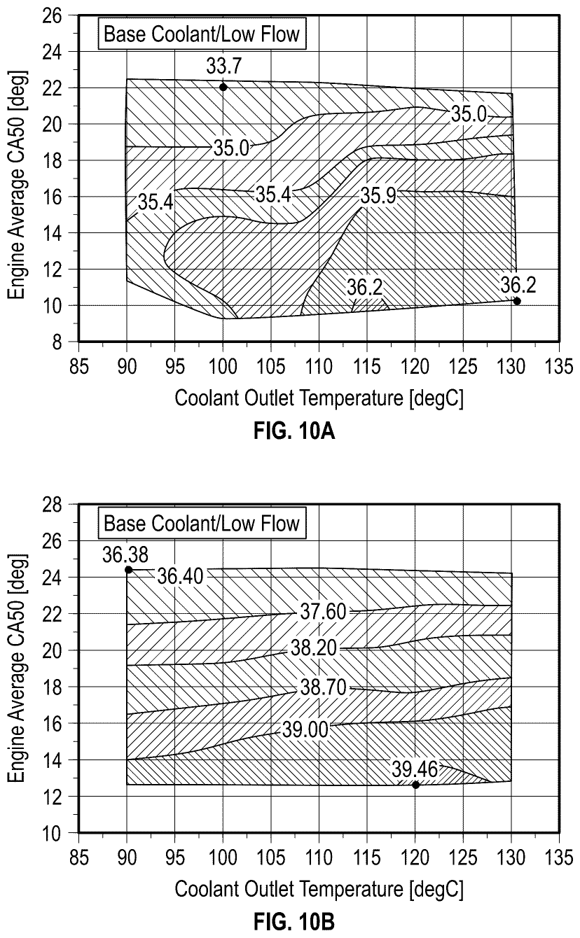

FIGS. 10A and 10B show contour plots of brake thermal efficiency (%) for diesel engines against engine average CA50 and coolant temperatures. FIG. 10A is at engine conditions of 1500 rpm and 5 bar BMEP, while FIG. 10B is at 1500 rpm and 10 bar BMEP. As shown in FIGS. 10A and 10B, high coolant temperature leads to high thermal efficiency due to low frictional losses.

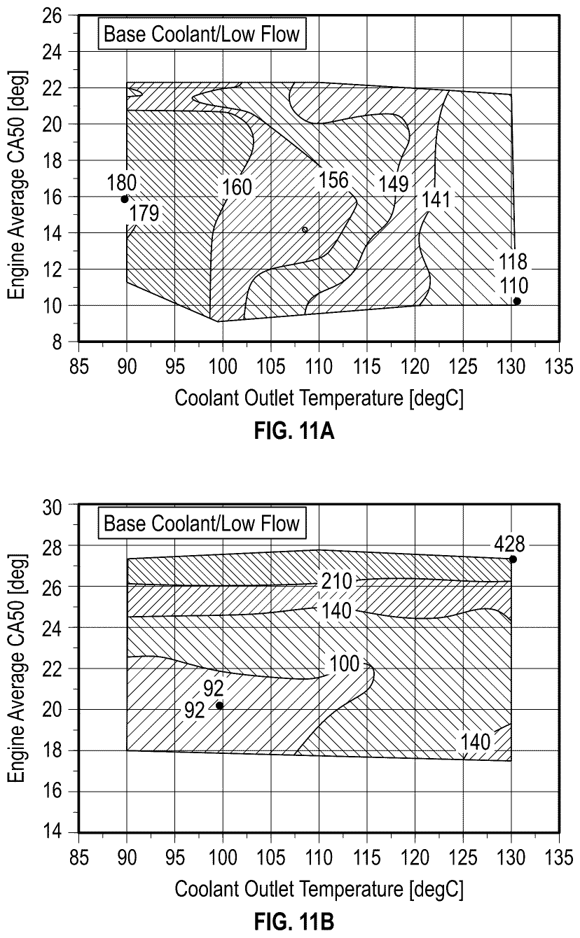

FIGS. 11A and 11B show contour plots of carbon monoxide emissions (ppm) for diesel engines against engine average CA50 and coolant temperatures. FIG. 11A is at engine conditions of 1500 rpm and 5 bar BMEP, while FIG. 11B is at 2000 rpm and 15 bar BMEP. FIGS. 11A and 11B indicate that high coolant temperature operation leads to low carbon monoxide emission at low loads while low coolant temperature operation leads to low carbon monoxide emissions at high loads. Thus, at high engine load operation for diesel engines, low coolant temperature operation is preferred since it results in low carbon monoxide emissions.

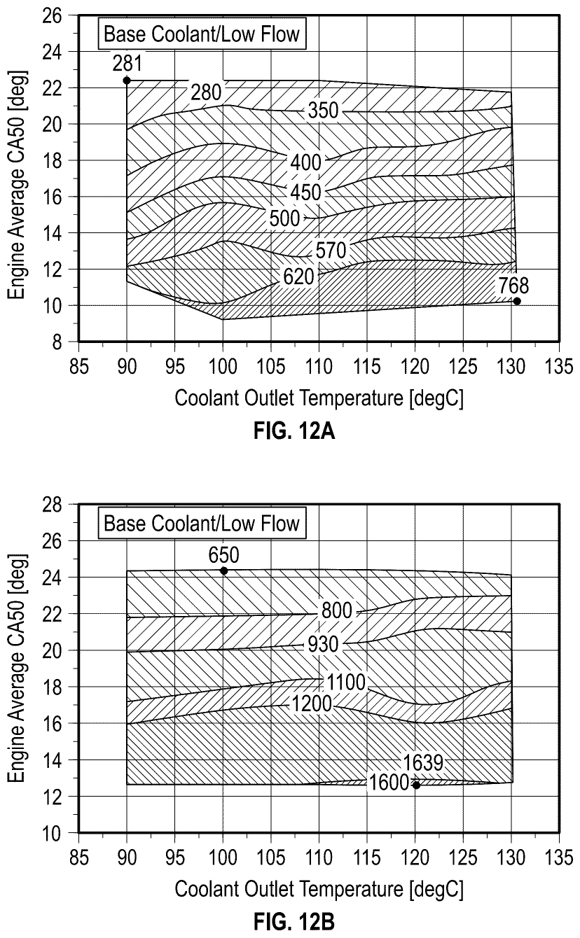

FIGS. 12A and 12B show contour plots of nitrogen oxide (NOx) emissions (ppm) for diesel engines against engine average CA50 and coolant temperatures. FIG. 12A is at engine conditions of 1500 rpm and 5 bar BMEP, while FIG. 12B is at 1500 rpm and 10 bar BMEP. FIGS. 12A and 12B both indicate that high coolant temperature operation leads to high NOx emissions for diesel engines, and thus, low coolant temperature, specifically in the engine head, is ideal for reducing NOx emissions. Combining the findings illustrated in FIG. 6A-12B support the strategy of using low engine head coolant temperatures to reduce NOx emissions while using high engine block coolant temperatures to reduce CO and PM emissions.

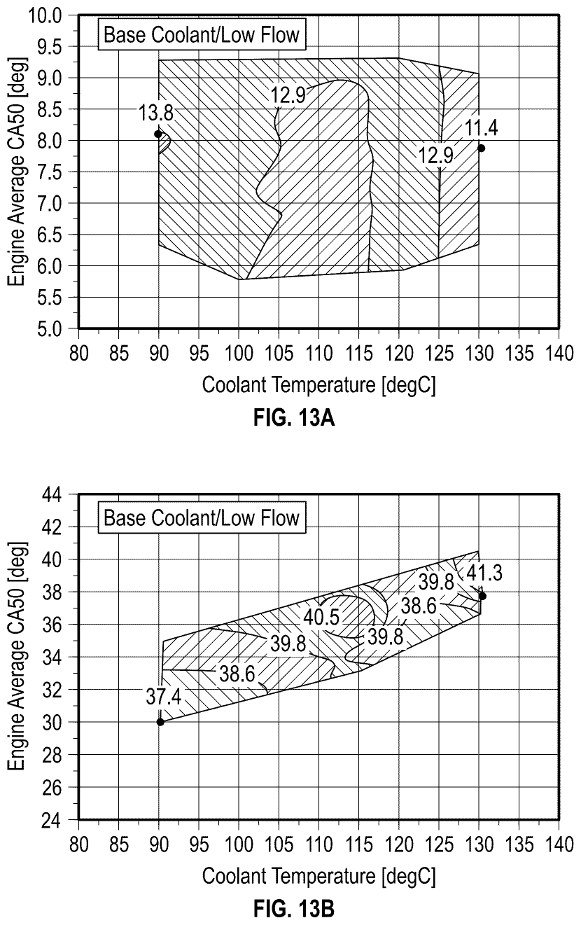

FIGS. 13A and 13B show contour plots of heat rejected (kW) to coolant from a gasoline engine against engine average CA50 and coolant temperatures. FIG. 13A is at engine conditions of 1500 rpm and 5 bar BMEP, while FIG. 13B is at 2000 rpm and 15 bar BMEP. FIG. 13A indicates that high coolant temperature operation leads to low heat rejection to the coolant at non-knock limited points. FIG. 13B indicates that high temperature coolant operation leads to high heat rejection to the coolant at knock limited points. Knock limited points require the combustion phasing to be delayed using spark timing to avoid knock, leading to higher temperatures in the cylinder late in the power stroke and increased heat transfer losses to the coolant.

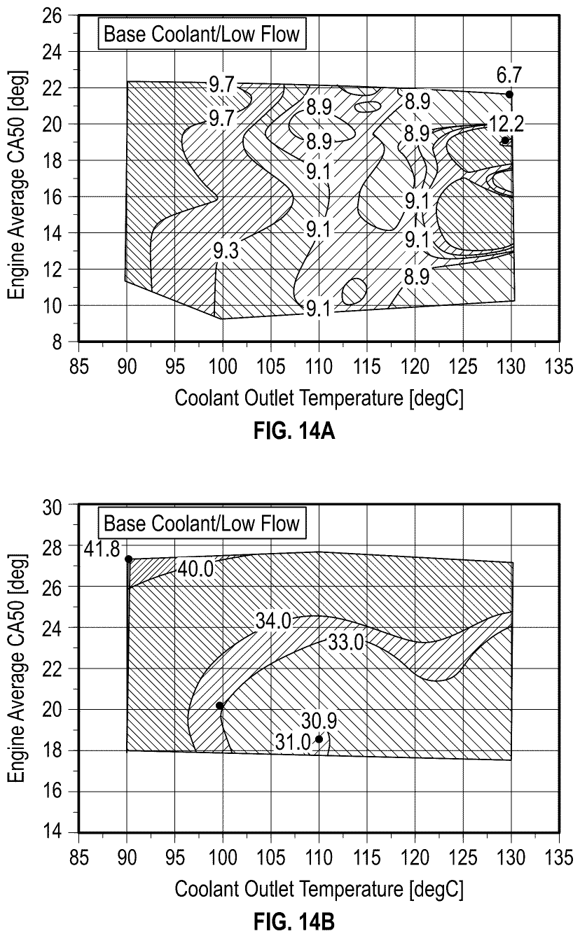

FIGS. 14A and 14B show contour plots of heat rejected (kW) to coolant by diesel engines against engine average CA50 and coolant temperatures. FIG. 14A is at engine conditions of 1500 rpm and 5 bar BMEP, while FIG. 14B is at 2000 rpm and 15 bar BMEP. FIGS. 14A and 14B show that high coolant temperature operation leads to low heat rejection to the coolant and lower heat transfer losses.

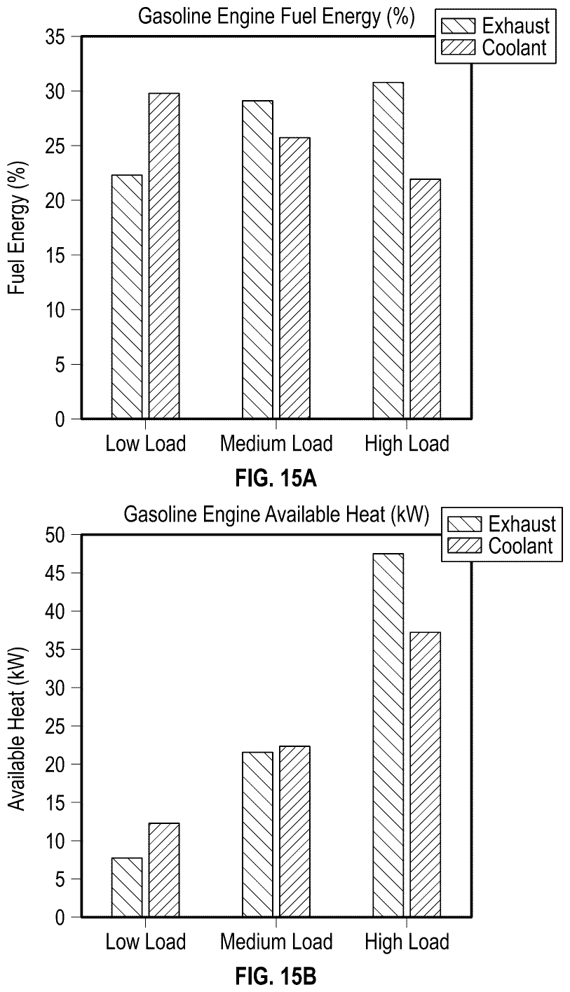

FIG. 15A shows the fuel energy (%) lost to the coolant and the exhaust for the cases of low engine low, medium engine load, and high engine load from a gasoline internal combustion engine. Specifically, at higher loads, the fuel energy (%) lost to the coolant decreases, and the percentage of fuel energy lost to the exhaust increases.

FIG. 15B shows available heat (kW) from both the exhaust and the coolant of a gasoline internal combustion engine that can be used in a mobile carbon capture system for cases of low engine load, medium engine load, and high engine load. Specifically, the available heat is higher for higher loads and lower for lower loads. At low and medium loads, the coolant has higher available heat, while at high loads the exhaust has higher available heat.

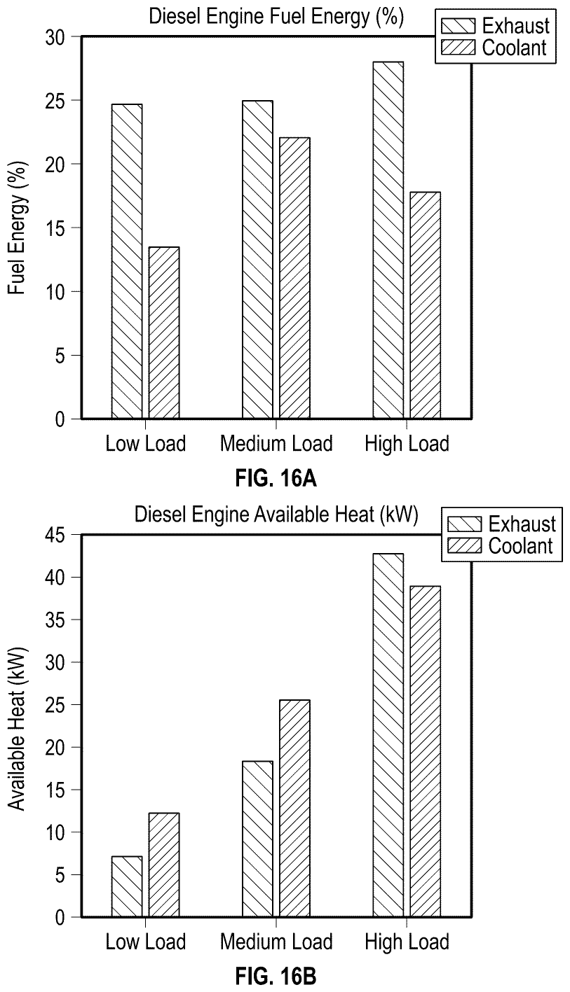

FIG. 16A shows fuel energy (%) that is lost to the coolant and the exhaust from a diesel internal combustion engine for cases of low engine load, medium engine load, and high engine load. Specifically, the percentage of fuel energy lost is higher for exhaust than the coolant and is highest for the exhaust under high loads while it is highest for the coolant at medium loads.

FIG. 16B shows available heat (kW) from a diesel internal combustion engine that can be used in a mobile carbon capture system for cases of against low engine load, medium engine load, and high engine load. Specifically, the available heat is higher for higher loads than low loads in both the exhaust and the coolant. The available heat is higher for the coolant at low and medium loads while it is lower for the coolant compared to the exhaust at high loads.

Embodiments of the present disclosure may provide at least one of the following advantages. By using both low temperature coolant in the engine head and high temperature coolant in the engine block for an internal combustion engine, the likelihood of knock is reduced while simultaneously reducing emissions by improving engine efficiency. The system also captures carbon dioxide emissions during operations, further reducing overall emissions. In general, carbon capture systems operate most efficiently at high temperatures as the partial pressure of carbon dioxide increases with temperature compared to the partial pressure of water. Thus, higher temperature carbon capture systems result in less water vaporized with the carbon dioxide, and are more efficient.

Using the exhaust gas and coolant helps the carbon capture system obtain high temperatures for high efficiency. The additional heat may also be used to produce a leaner solvent, reducing the liquid circulation rate and space required for carbon dioxide absorption. Additionally, using the cooled coolant for heat rejection for the carbon capture system assists in eliminating additional air-cooled heat exchangers and glycol circulation loops often required by conventional carbon capture systems. By maintaining a lower temperature at the engine head and a high temperature at the engine block, the high temperature of the engine block reduces heat transfer and friction losses in the engine.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including. ” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

1. A method to reduce carbon dioxide emissions from an engine, comprising:
combusting a fuel in the engine to yield an exhaust gas, wherein the engine includes at least an engine head and an engine block;
feeding a coolant to the engine head at a first temperature, and recovering an engine head coolant at a second temperature;
flowing a first portion of the engine head coolant through a restricting valve to increase a temperature of the first portion of the engine head coolant to a third temperature;
feeding the first portion of the engine head coolant from the restricting valve to the engine block, and recovering an engine block coolant at a fourth temperature; and
recirculating a second portion of the engine head coolant back to the engine head.

2. The method of claim 1, the method further comprising:
recovering heat from the exhaust gas in a lean solvent heater, wherein the lean solvent heater outputs a cooled exhaust;
recovering heat from the first cooled exhaust in an exhaust trim cooler, wherein the exhaust trim cooler outputs a second cooled exhaust;
transferring heat from a carbon dioxide lean solvent to a carbon dioxide rich solvent in a crossflow heat exchanger to produce a first cooled carbon dioxide lean solvent and a first heated carbon dioxide rich solvent;
feeding the second cooled exhaust to an absorber to contact a second cooled carbon dioxide lean solvent to absorb carbon dioxide, wherein the absorber produces the carbon dioxide rich solvent stream and a carbon dioxide reduced exhaust stream;
recovering heat from the engine block coolant via indirect contact with a first heated carbon dioxide rich solvent in a rich solvent heater to produce a second heated carbon dioxide rich solvent and a first cooled engine block coolant;
feeding the second heated carbon dioxide rich solvent to a regeneration column;
desorbing carbon dioxide from the second heated carbon dioxide rich solvent in the regeneration column to produce the carbon dioxide lean solvent stream and a carbon dioxide stream; and
compressing and storing carbon dioxide from the carbon dioxide stream.

3. The method of claim 2, wherein at least the engine, the absorber, the regeneration column, the crossflow heat exchanger, and the rich solvent heater are disposed in an automobile.

4. The method of claim 2, wherein the coolant is a first coolant wherein the carbon dioxide stream is a first carbon dioxide stream, further comprising:
feeding a second coolant to the exhaust trim cooler to recover heat from the cooled exhaust, producing the second cooled exhaust;
feeding the second coolant to a lean solvent trim cooler to recover heat from the first cooled carbon dioxide lean solvent stream, producing the second cooled carbon dioxide lean solvent;
feeding the second coolant to a carbon dioxide heat exchanger, wherein the carbon dioxide heat exchanger is configured to condense the first carbon dioxide stream to yield a condensed carbon dioxide stream;
feeding the condensed carbon dioxide stream to a liquid separator, wherein the liquid separator outputs a second carbon dioxide stream;
feeding the second coolant to a compressor, wherein the compressor is configured to compress the second carbon dioxide stream to yield a compressed carbon dioxide stream;
storing the compressed carbon dioxide stream; and
circulating the second coolant through a first heat exchanger to cool the second coolant.

5. The method of claim 4, wherein the second coolant is cooled to a temperature below 40° C.

6. The method of claim 2, further comprising recovering heat from the exhaust gas using a lean solvent heater and the exhaust trim cooler, wherein the lean solvent heater and the exhaust trim cooler are arranged in series.

7. The method of claim 6, the method further comprising: feeding a regeneration column bottom lean solvent to the lean solvent heater to recover heat from the exhaust gas, producing a heated regeneration column bottom lean solvent and the cooled exhaust.

8. The method of claim 2, wherein the heated carbon dioxide rich solvent is a first heated carbon dioxide rich solvent, wherein the rich solvent heater is a first rich solvent heater, the method further comprising:
heating the first heated carbon dioxide rich solvent exiting the first rich solvent heater in a second rich solvent heater to yield a third heated carbon dioxide rich solvent, and wherein the second rich solvent heater uses heat from the exhaust gas;
heating the third heated carbon dioxide rich solvent exiting the second rich solvent heater in a third rich solvent heater to yield the second heated carbon dioxide rich solvent; and
wherein the first rich solvent heater, the second rich solvent heater and the third rich solvent heater are arranged in series.

9. The method of claim 8, the method further comprising:
regulating a pressure in an effluent line exiting each of the first rich solvent heater, the second rich solvent heater, and the third rich solvent heater to ensure a temperature in each of the effluent lines is less than 125° C.

10. The method of claim 2, wherein the heated carbon dioxide rich solvent is a first heated carbon dioxide rich solvent, wherein the rich solvent heater is a first rich solvent heater, the method further comprising:
heating a second portion of the first heated carbon dioxide rich solvent in a second rich solvent heater, wherein the second rich solvent heater is arranged in parallel with the first rich solvent heater, and wherein the second rich solvent heater uses heat from the exhaust gas.

11. The method of claim 1, wherein the first temperature is between 60 and 90° C.

12. The method of claim 1, wherein the second temperature is greater than the first temperature.

13. The method of claim 1, wherein the third temperature is between 90 and 100° C.

14. The method of claim 1, wherein the fourth temperature is between 100 and 120° C.

15. The method of claim 1, the method further comprising:
heating the engine block coolant using the exhaust gas in a coolant-exhaust heat exchanger, producing a cooled exhaust gas; and
flowing the cooled exhaust gas to the engine head to use as Exhaust Gas Recirculation (EGR).

16. The method of claim 2, wherein a temperature of the carbon dioxide rich solvent stream is less than 10° C.

17. The method of claim 1, further comprising:
combining the second portion of the engine head coolant with the cooled engine block coolant, producing a combined coolant stream;
feeding the combined coolant stream to a second heat exchanger and a third pump to produce the pumped combined coolant.

18. A system for capturing carbon dioxide emissions from an engine, comprising:
an engine head and an engine block;
a restricting valve situated in a first flow line exiting the engine head, wherein the restricting valve is configured to increase a temperature of a first portion of an engine head coolant flowing between the engine head and the engine block; and
a second flow line exiting the engine head, wherein the second flow line is configured to recirculate a second portion of the engine head coolant back toward the engine head.

19. The system of claim 18, the system further comprising:
a rich solvent heater downstream from the engine block, wherein the rich solvent heater is configured to:
cool an engine block coolant exiting the engine block;
heat a first heated carbon dioxide rich solvent; and
yield a first cooled engine block coolant and a second heated carbon dioxide rich solvent;
a lean solvent heater downstream from the engine block, wherein the lean solvent heater is configured to:
to recover heat from an exhaust gas produced by the engine; and
provide heat to a carbon dioxide lean solvent; and
yielding a cooled exhaust and a heated regeneration column bottom lean solvent;
an exhaust trim cooler downstream from the lean solvent heater and upstream from an absorber, wherein the exhaust trim cooler is configured to remove heat from the first cooled exhaust to yield a second cooled exhaust;
the absorber upstream from a regeneration column, wherein the absorber is configured to:
receive the second cooled exhaust and a second cooled carbon dioxide lean solvent exiting a lean solvent trim cooler;
yield the carbon dioxide rich solvent and a carbon dioxide reduced exhaust;
a crossflow heat exchanger downstream from the absorber, the crossflow heat exchanger configured to:
heat the carbon dioxide rich solvent,
cool a carbon dioxide lean solvent, and
yield a first carbon dioxide lean solvent and a first heated carbon dioxide rich solvent; and
the regeneration column configured to:
receive the second heated carbon dioxide rich solvent and the heated regeneration column bottom lean solvent; and
yield the carbon dioxide lean solvent and a first carbon dioxide stream.

20. The system of claim 19, the system further comprising:
a carbon dioxide heat exchanger downstream from the regeneration column, the carbon dioxide heat exchanger configured to condense the first carbon dioxide stream to yield a condensed carbon dioxide stream;
a liquid separator downstream from the carbon dioxide heat exchanger, the liquid separator configured to: remove water from the condensed carbon dioxide stream to yield a second carbon dioxide stream; and
a compressor downstream from the liquid separator, the compressor configured to compress the second carbon dioxide stream to yield a compressed carbon dioxide stream for storage.
